(19) United States
(12) Patent Application Publication
(10) Pub. No.: US 2025/0384429 A1
(43) Pub. Date: Dec. 18, 2025

(54) SYSTEMS AND METHODS FOR AUTOMATIC MOBILE DRIVER'S LICENSE-BASED TRANSACTION MANAGEMENT

(71) Applicant: Wells Fargo Bank, N.A., San Francisco, CA (US)

(72) Inventors: Jenny Y. Tao, Philadelphia, PA (US); Prafullata Diwate, San Francisco, CA (US); Hao Li, Charlotte, NC (US); Elizabeth Mellers, San Francisco, CA (US)

(21) Appl. No.: 18/742,082

(22) Filed: Jun. 13, 2024

(51) Int. Cl. G06Q 20/36; G06Q 20/40

(52) U.S. Cl. CPC G06Q 20/3674; G06Q 20/40145

(57) ABSTRACT

Systems, apparatuses, methods, and computer program products are disclosed for providing automatic mobile driver's license (mDL)-based transaction verification. An example method includes receiving a transaction attempt associated with a user device of a user. The example method further includes determining whether the transaction attempt is associated with one or more restricted items. The example method further includes determining whether the transaction attempt indicates that an mDL associated with the user is comprised in the user device in an instance in which the transaction attempt is associated with the one or more restricted items. The example method further includes authenticating, based on the one or more restricted items, the user based on the mDL associated with the user and handling the transaction attempt based on authenticating the user.

### BACKGROUND

When purchasing restricted items (e.g., alcohol, tobacco products, firearms, prescription medications, hazardous materials, controlled substances, and/or the like), a buyer may be required to present government-issued photo identification (ID) (e.g., a driver's license, a state ID, a residence card) along with supplemental required documentation (e.g., a firearm license or permit, a doctor's prescription) to ensure compliance with government regulations. If the purchase is made in-store, the buyer is often required to bring the physical government-issued photo ID along with the supplemental required documentation and present them to a clerk, clerk, representative, and/or the like for verification. If the purchase is made online, the buyer may be prompted to fill out online forms to provide any required information and/or upload pictures of the physical government-issued photo ID and/or the supplemental required documentation.

### BRIEF SUMMARY

Purchasing restricted items (e.g., alcohol, tobacco products, firearms, prescription medications, hazardous materials, controlled substances, and/or the like) may require multiple steps of user verification based on various requirements to ensure compliance with the government regulations. For example, in order to purchase alcohol and/or tobacco products, a buyer may be required to provide a government-issued photo ID (e.g., a driver's license, a state ID, a residence card) in order to prove they are of a minimum legal age. As another example, a buyer may be required to verify their identity by providing one or more government-issued ID's (e.g., driver's license, state ID, passport) in order to purchase firearms, prescription medications, restricted chemicals, and/or hazardous materials.

Furthermore, various legal documentation (e.g., a firearm license or permit, a doctor's prescription) may require further verification in addition to a government-issued photo ID. For example, many jurisdictions require verification of a firearm license or firearm permit before a buyer is permitted to purchase firearms and/or ammunition. As another example, many jurisdictions require verification of a doctor's prescription before a buyer is permitted to purchase prescription medications. As yet another example, many jurisdictions require verification of various legal documentation indicating that an individual has legitimate reason to purchase restricted chemicals and/or hazardous materials and that the individual is aware that safe handling is required to utilize such restricted chemicals and/or hazardous materials.

When a restricted purchase is made in-store, a buyer may be required to bring a physical, government-issued photo ID along with supplemental required documentation and present them to a clerk (e.g., salesperson, practitioner, government agency representative, authoritative entity, and/or the like) for examination. If any supplemental required documentation is not physically presented (e.g., the buyer forgot to bring the supplemental required documentation to the store), the restricted purchase may be denied. In some circumstances, a clerk may verify the government-issued ID and/or supplemental required documentation associated with a buyer through visual examination. However, such visual verification may be time-consuming and may require the clerk to check the government-issued photo ID and/or supplemental required documentation very thoroughly. Furthermore, such visual verification may introduce security risks. For example, if one or more of the government-issued photo ID and/or the supplemental required documentation are counterfeited (e.g., forged) by a bad actor, it may be difficult for the clerk to determine that the government-issued photo ID and/or the require documentation has been counterfeited.

When a restricted purchase is made online, a buyer may be prompted to fill out online forms to provide any required information and/or upload pictures of their government-issued photo ID and/or any other supplemental required documentation needed to purchase one or more restricted items. A user verification process required to purchased restricted items online may be difficult (e.g., complex, lengthy) for various buyers (e.g., individuals that are unfamiliar with the technology involved and/or individuals that have accessibility concerns), thus making the online purchase and user verification process time-consuming and/or prohibitive for various individuals. Furthermore, such a user verification process associated with an online purchase may introduce security concerns that are not inherent in an in-store purchase. For example, if a bad actor steals another individual's identity, the bad actor may be enabled to purchase one or more restricted items online using that individual's identity. As such, traditional verification processes, both in-store or online, may be inefficient, overly complex, and/or susceptible to fraud (e.g., impersonation fraud, identity theft).

It is therefore desirable to provide a system configured to autonomously, efficiently, and securely execute various user authentication and/or user identity verification processes in order to facilitate the purchase of various restricted items. Accordingly, embodiments described herein provide may perform user authentication and/or user verification based on a mobile driver's license (mDL) associated with a user by employing a smart mobile wallet management system. The smart mobile wallet management system may be configured to leverage an mDL associated with a user that is stored in a user device (e.g., a mobile phone, tablet computer, and/or the like) and/or a smart mobile wallet associated with the user in order to facilitate one or more transactions associated with one or more restricted items and/or sensitive data (e.g., financial data, personal data).

In such examples, the mDL associated with the user may be accessed and/or utilized via a software application instance (e.g., mobile application, mDL application) associated with the smart mobile wallet management system. As such, the smart mobile wallet management system described herein may be configured to perform various mDL-based verification and/or user authentication processes in order to facilitate the purchase of one or more restricted items, facilitate the secure transfer of disbursement payments (e.g., payments related to a personal loan, a loan offered based on a government initiative (e.g., an economic injury disaster loan (EIDL), a paycheck protection program (PPP) loan), and/or the like), facilitate secure mobile check deposits, and/or the like. By leveraging an mDL associated with a respective user, the smart mobile wallet management system eliminates the need to for a user to provide a physical government-issued photo ID and/or other supplemental required documentation to a clerk (e.g., salesperson, practitioner, government agency representative, authoritative entity, and/or the like) while executing various restricted transactions.

As an example, if a user is attempting to purchase one or more restricted items in-store (e.g., alcohol, tobacco products, firearms, prescription medications, hazardous materials, controlled substances, and/or the like) using a payment method stored in a smart mobile wallet (e.g., a payment card, payment account) which also includes an mDL associated with the user, the smart mobile wallet management system may detect the restricted items and authenticate the user based on their mDL in order to verify that the user satisfies the minimum legal age requirements for purchasing the restricted items. In such examples, the smart mobile wallet management system may autonomously access the mDL stored in the user's smart mobile wallet to confirm date of birth data and/or age data associated with the user's mDL to verify that the user's age satisfies the minimum legal age requirement for purchasing the restricted items.

Additionally, in some examples, the smart mobile wallet management system may be configured to capture biometric data (e.g., image data associated with the user's face, eyes, body posture, fingerprint geometry data, palm print geometry data, voiceprint data) associated with the user, and compare the captured biometric data to known biometric data associated with the user (e.g., known user portrait image data associated with the user's mDL). In some examples, the smart mobile wallet management system may be configured to leverage a biometric capturing system associated with a respective merchant to capture biometric data (e.g., image data associated with the user's face) and compare the captured biometric data to the known biometric data in order to verify and/or authenticate the user. Additionally or alternatively, the smart mobile wallet management system may be configured to leverage a user device (e.g., a smart phone, table computer) associated with the user to capture biometric data associated with the user.

In some examples, if the verification of the user is successful based on the mDL of the user and/or the biometric data associated with the user, the user may be enabled to purchase various restricted items (e.g., alcohol, tobacco products, firearms, prescription medications, hazardous materials, controlled substances, and/or the like). Alternatively, if the verification of the user is unsuccessful, the smart mobile wallet management system may provide a rejection alert to a user device associated with the user indicating the failed user verification. Furthermore, in some embodiments, the smart mobile wallet management system may be configured to remove one or more of the restricted items (e.g., alcohol, tobacco products, firearms, prescription medications, hazardous materials, controlled substances, and/or the like) from the respective transaction attempt. Additionally, in some examples, the smart mobile wallet management system may provide a confirmation to a user device associated with the user after the purchase is executed that indicates that the mDL associated with the user has been used to verify the user while purchasing the restricted items. In this manner, the verification process may be completed without any direct user interaction.

Although the examples described hereinabove are related to purchasing restricted items, the present disclosure contemplates that the smart mobile wallet management system may be utilized in many other scenarios which require a verification process utilizing a government-issued photo ID. For example, the smart mobile wallet management system may be configured to execute one or more user verification processes on behalf of a user as the user deposits a check online (e.g., during a mobile deposit process associated with a financial institution), as the user applies for a personal loan or personal line of credit, as the user applies for a visa and/or work permit, as the user participates in various age-restricted activities (e.g., gambling activities), and/or the like.

Example embodiments thus provide many benefits in contrast to conventional transaction management systems and techniques by executing various user verification processes and/or authentication processes autonomously without requiring direct interaction on the part of a user and/or a clerk associated with a respective transaction attempt. For example, if a user is making a purchase in-store or online, the smart mobile wallet management system may automatically identify various restricted items and perform one or more corresponding user authentication operations in the background without the user and/or a clerk being involved. For example, during in-store purchases, a user may not need to provide a physical government-issued photo ID and/or other supplemental required documentation to a clerk to purchase the restricted items, nor would the clerk need to visually examine the physical government-issued ID and/or other supplemental required documentation. Additionally, during online purchases, the user may not need to scan and/or upload their government-issued photo ID and/or other supplemental required documentation. One or more mDL-based verification processes may be executed by the smart mobile wallet management system in the background while the user is focusing on making the purchase, making online transactions efficient and seamless.

In addition, example embodiments are capable of performing user verification securely and accurately while avoiding human mistakes by utilizing biometric data associated with the user and/or the mDL of the user. In this regard, the smart mobile wallet management system may capture biometric data automatically during a transaction (e.g., by capturing image data associated with the user) and/or through a request (e.g., asking the user to speak a few sentences) and compare the captured biometric data with known biometric data (e.g., known image data related to the user's facial features, known voiceprint data) associated with the user and/or the user's mDL. Using traditional verification methods, a clerk would have to manually verify the user by comparing the portrait of the user on a government-issued photo ID with the user's face. If a counterfeit photo ID is presented to the clerk, the clerk may have a difficult time making a correct judgement on whether the photo ID is valid in a short period of time. As such, the mDL-based verification mitigates potential human error and addresses known fraud risks.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a smart mobile wallet management system.

FIG. 2 illustrates a schematic block diagram of example circuitry embodying a system device that may perform various operations in accordance with some example embodiments described herein.

FIG. 3 illustrates a schematic block diagram of example circuitry embodying a user device that may perform various operations in accordance with some example embodiments described herein.

FIG. 4 illustrates an example flowchart for providing automatic mDL-based transaction management in accordance with some example embodiments described herein.

FIG. 5 illustrates an example user interface associated with mDL indicia in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “smart mobile wallet” refers to a digital application or a digital service which allows users to securely store, manage, and/or facilitate transactions with various forms of digital currency and/or payment methods using a mobile computing device such as a mobile phone, tablet computer, or smartwatch. The smart mobile wallet may store digital identification documents associated with a respective user (e.g., an mDL), personal information (e.g., user preferences, transaction history, security settings, health conditions, food restrictions), payment methods (e.g., credit/debit card information, loyalty card information, digital coupons), payment account data (e.g., account numbers, routing numbers), cryptocurrency account data (e.g., date related to crypto currencies such as Bitcoin, Ethereum, Litercoin, and/or the like owned by the user), personal itinerary data (e.g., data related to boarding passes, event tickets, scheduled activities), and/or security keys for securely accessing and managing the stored personal information (e.g., passcodes, passwords, private keys associated with public/private key pairs), and/or any other relevant digital assets associated with the user. A smart mobile wallet provides a convenient, secure and contactless method for users to store personal information and/or to make payments either in-store or online.

### System Architecture

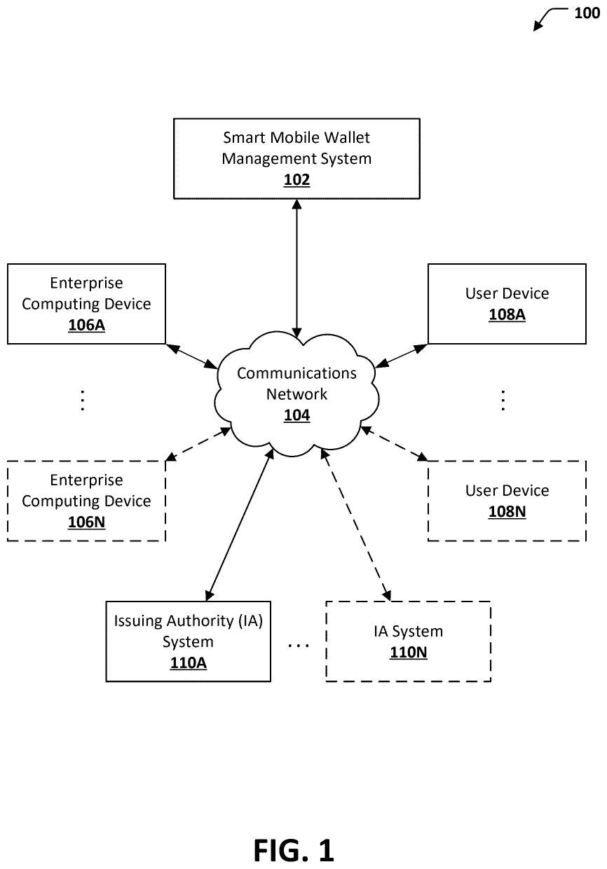

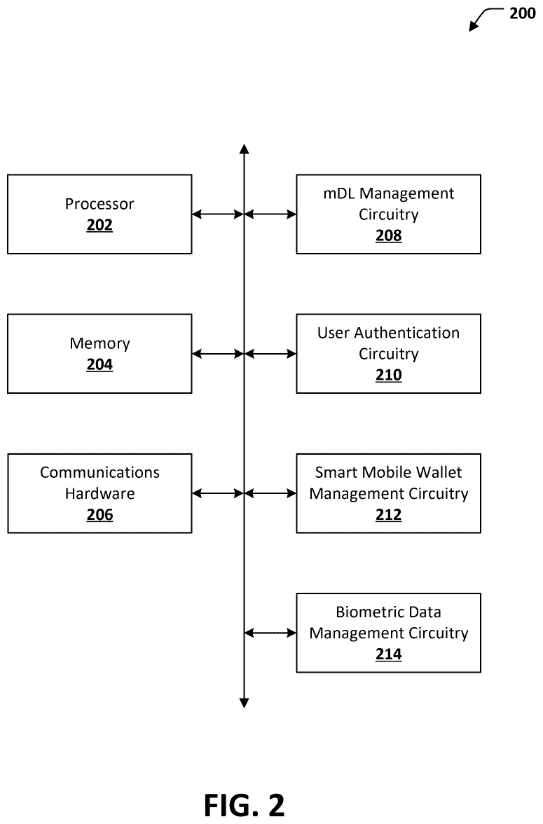

Example embodiments described herein may be implemented using any of a variety of computing devices or servers. To this end, FIG. 1 illustrates an example environment 100 within which various embodiments may operate. As illustrated, a smart mobile wallet management system 102 may receive and/or transmit information via communications network 104 (e.g., the Internet) with any number of other computing devices and/or computing systems, such as one or more of enterprise computing devices 106A-106N, user devices 108A-108N, and/or issuing authority (IA) systems 110A-110N. The smart mobile wallet management system 102 may be implemented as one or more computing devices or servers, which may be composed of a series of components. Particular components of the smart mobile wallet management system 102 are described in greater detail below with reference to apparatus 200 in connection with FIG. 2.

In various embodiments, the smart mobile wallet management system 102 may be associated with an enterprise (e.g., a financial institution, bank, and/or the like) and may be configured to manage various smart mobile wallet processes for users associated with said enterprise. For example, the smart mobile wallet management system 102 may be configured to manage, execute, initiate, and/or otherwise facilitate one or more restricted item purchase processes, transaction auditing processes, mobile deposit processes, disbursement payment processes, payment account linking processes, payment account transaction processes, smart mobile wallet processes, mDL authentication processes, user identity verification process, user authentication processes, and/or the like for a plurality of users associated with the respective enterprise.

In this regard, various users associated with an enterprise may interact with the smart mobile wallet management system 102 via a software application instance, where the software application instance may be configured to facilitate one or more of the various restricted item purchase processes, transaction auditing processes, mobile deposit processes, smart mobile wallet processes, mDL authentication processes, and/or other processes described herein. In various embodiments, the software application instance associated with the smart mobile wallet management system 102 may be installed and/or downloaded to a user device (e.g., a user device 108A configured as a mobile device, laptop, and/or the like) and may present one or more user interface configurations to a respective user.

As such, the software application instance associated with the smart mobile wallet management system 102 may be configured to guide a user through the various steps of a mobile deposit process, a disbursement payment claim process, a payment account linking process, and/or the like that may require a user to be authenticated based on a corresponding mDL. For example, the software application instance associated with the smart mobile wallet management system 102 may be configured to cause display of various interactive user interface elements to the user that are configured to enable the user to manage one or more portions of smart mobile wallet data (e.g., payment account data, payment card data, and/or the like) and/or user data (e.g., user attribute data, user profile data, user account data, and/or other user data).

In some embodiments, the software application instance may be configured to enable a user to access a smart mobile wallet (e.g., a digital wallet) configured to manage one or more of a user's mDL, payment accounts (e.g., credit accounts, checking accounts, savings accounts, investment accounts), and/or payment cards (e.g., credit cards, debit cards, and/or the like associated with the user's payment accounts) that are associated with a respective enterprise employing the smart mobile wallet management system 102. Additionally or alternatively, in various embodiments, the software application instance associated with the smart mobile wallet management system 102 may be configured to enable a user to access a software application framework related to a respective enterprise by, for example, providing (e.g., transmitting, enabling, toggling, configuring) one or more access permissions for a user device (e.g., a user device 108A) associated with the user, where the one or more access permissions enable the user device to access the software application framework associated with the enterprise.

As described herein, the smart mobile wallet management system 102 may be configured to receive transaction attempts associated with a user, where a transaction attempt may be an attempt to execute the purchase of one or more goods and/or services using a payment account associated with the user, an attempt to remotely deposit a check to a payment account associated with the user, claim a disbursement payment associated with the user, and/or the like. As such, the smart mobile wallet management system 102 may be configured to integrate and/or communicate with one or more computing systems associated with an affiliated enterprise (e.g., a financial institution, banking institution, and/or the like) and/or one or more clearinghouses authorized to settle financial transactions (e.g., purchases, money transfers) between various merchants and the enterprise on behalf of one or more users. Furthermore, the smart mobile wallet management system 102 may be configured to determine whether a respective transaction attempt should be declined such that the transaction is terminated (e.g., declined, cancelled), or allowed such that funds are transferred from, or deposited to, a respective payment account of the user. In this regard, the smart mobile wallet management system 102 may be configured to cause an appropriate amount of funds to be withdrawn from one or more payment accounts associated with the user based on any legitimate transaction executed utilizing a payment method (e.g., payment card, digital payment card, account number, routing number, and/or the like) associated with the one or more payment accounts.

In some embodiments, the smart mobile wallet management system 102 may be configured to facilitate the execution of one or more processes related to automatically authenticating a respective user based on an mDL associated with the respective user. For example, the smart mobile wallet management system 102 may be configured to authenticate a user based on a respective mDL associated with the user based on a determination that a respective transaction attempt is associated with one or more restricted items (e.g., alcohol, tobacco products, firearms, prescription medications, hazardous materials, controlled substances, and/or the like). In this regard, the smart mobile wallet management system 102 may be configured to store, integrate with, manage, and/or utilize one or more mDLs (and/or data related to the one or more mDLs (e.g., mDL identifying information, cryptographic key information)) associated with a respective user in order to facilitate the various operations described herein. As used herein, the term “mDL” covers various mobile (e.g., digital) identity credential types associated with a respective user including mobile driver's licenses and mobile identification cards. An mDL may be an electronically managed data structure configured to be accessed, processed, and/or otherwise utilized by the smart mobile wallet management system 102 for various user authentication processes.

In this regard, an mDL may be configured to store or point to (e.g., programmatically reference) various credential data associated with a respective user including, but not limited to, personally identifiable information (PII) (e.g., given name, family name, name prefix, name suffix, driver's license number, social security number, administrative number), user information (e.g., height, eye color, hair color, date of birth, age, organ donor status, veteran status, gender information, sex information, race information, ethnicity information, user portrait image data, user signature data), contact information (e.g., residential address information, phone number, email address), credential validity data (e.g., credential issue dates, credential expiration dates, credential revocation status), credential endorsement data (e.g., hazmat endorsement, commercial driver's license (CDL) data, Department of Homeland Security (DHS) compliance data (e.g., “REAL ID” compliance data)), credential restriction data (e.g., driving restrictions, driving conditions, vehicle weight class restrictions), and/or the like associated with the respective user. Additionally, an mDL may be configured to store and/or point to various cryptographic key information (e.g., public key information used to identify the mDL, a corresponding user device, and/or a corresponding user) and/or originating IA data (e.g., cryptographic key information and/or identifying data associated with an originating IA). Additionally or alternatively, in various examples, an mDL may be configured to store, point to (e.g., programmatically reference), and/or otherwise be associated with various legal documentation associated with the user (e.g., a firearm license or permit, hazardous material purchase permit, medical prescriptions, and/or the like) which may be required for various user verification and/or authentication processes associated with the purchase of various restricted items (e.g., firearms, prescription medications, chemicals, hazardous materials, controlled substances, and/or the like).

An mDL may be issued (e.g., provisioned) to a respective user by an IA system 110A associated with a particular IA. An IA may be an entity that is legally entitled (or otherwise recognized as the relevant authority) to issue credentials, such as driver's licenses and/or other identification cards. An IA system 110A may be a computing system (e.g., a server system) associated with an agency, department, regulatory body, and/or government office entitled to issue legal credentials within a particular jurisdiction such as a respective county, township, state, province, or nation (in some implementations, an IA system may be a private organization authorized to act as the IA for a corresponding physical region). For example, an IA system 110A may be associated with a branch of the Department of Motor Vehicles (DMV) within a particular state in the United States (e.g., North Carolina) that is legally entitled to issue credentials (e.g., mDLs, driver's licenses, state identification cards) to individuals residing in that particular state. In some embodiments, an mDL may be issued in compliance with various national credentialing initiatives (e.g., REAL ID compliance) and/or may be issued under various licensing programs (e.g., the Enhanced Driver's License program (EDL)). Additionally or alternatively, in some embodiments, an mDL may be administered, managed, employed, and/or otherwise utilized by the smart mobile wallet management system 102 in compliance with various standards set forth by the American Association of Motor Vehicle Administrators (AAMVA). Additionally or alternatively, in some embodiments, an mDL may be administered, managed, employed, and/or otherwise utilized by the smart mobile wallet management system 102 in compliance with various standards set forth by the International Organization for Standardization and the International Electrotechnical Commission (IEC) (e.g., ISO/IEC 18013-5). It will be understood that other standards may apply in some implementations.

An mDL may be a digital version of a physical legal credential (e.g., a driver's license) associated with a user and may comprise and/or be associated with the same data as the legal credential. In some embodiments, an mDL associated with a user may be stored in a storage device (e.g., a server system) of an IA system 110A and one or more portions of credential data related to the mDL may be retrieved in real time, or near-real time, during a transaction associated with the user (e.g., an online transaction requiring user authentication, user age verification, and/or the like). Additionally or alternatively, once an mDL is issued to a user by a respective IA (e.g., by way of a corresponding IA system 110A), the mDL may be stored locally on a user device associated with the user (e.g., user device 108A) such that the mDL may be used without relying on a communications network (e.g., communications network 104). Additionally or alternatively, in some embodiments, an mDL may be stored in a smart mobile wallet associated with the user and managed by the smart mobile wallet management system 102, and the mDL may be accessed and/or utilized by the user via the smart mobile wallet to execute various mDL-based transactions.

In some examples, an IA may provision an mDL to a particular user device (e.g., user device 108A) associated with a user such that the mDL is associated with various user device identification data related to the particular user device (e.g., cryptographic identification data such as a public key). This may ensure that an mDL associated with a respective user cannot be transferred to multiple devices without authorization by the IA system (e.g., IA system 110A) and used in fraudulent transactions. Furthermore, associating an mDL with a particular user device (e.g., user device 108A) also enables the smart mobile wallet management system 102 and/or an IA system of an IA (e.g., IA system 110A) to verify that the intended user of the mDL is in possession of the mDL. Further still, associating an mDL with a particular user device (e.g., user device 108A) also ensures the safe transfer of sensitive credential data to and/or from the intended user of the mDL. In various examples, a user may store multiple copies of an mDL on multiple user devices (e.g., user devices 108A-108N). However, in such examples, each respective copy of the mDL may be cryptographically coupled to a respective user device by the IA system (e.g., IA system 110A) which provisioned the mDL. In this manner, each copy of the mDL can be independently verified against a respective user device to ensure that an mDL, or credential data associated with the mDL, cannot be transferred to unauthorized user devices.

An mDL may be associated with various mDL data security mechanisms used to ensure the validity of the mDL, authenticate an originating IA that issued the mDL, protect a user's personal data, and/or facilitate secure mDL-based transactions. In this regard, an mDL may be associated with a mobile security object (MSO) and/or various public and private cryptographic key information. An MSO is an electronically managed data structure that enables the authentication of the accuracy and origin of various credential data associated with the mDL during mDL-based transactions. In various examples, an MSO is associated with one or more portions of credential data related to the issue date, expiration date, user signature, and/or expected credential update time associated with the mDL. In various embodiments, the one or more portions of credential data associated with the MSO may be used to verify the validity and/or status of the mDL during various transactions. For example, if the credential data associated with the MSO indicates that the mDL is expired, the corresponding user may not be permitted to engage in one or more transactions using the mDL (e.g., one or more age-restricted purchase transactions).

Additionally, an mDL may be associated with various cryptographic key information (e.g., public/private key pair information) that may be utilized by the smart mobile wallet management system 102 to authenticate an originating IA that issued the mDL, verify one or more portions of credential data associated with an mDL, and/or facilitate various mDL-based transactions (e.g., retail purchase transactions, user authentication protocols, mDL data queries) for a user associated with the mDL. For example, an IA associated with a respective IA system 110A may be associated with a unique public key that may be utilized by the smart mobile wallet management system 102 to identify and/or authenticate the originating IA of a respective mDL. As such, in various examples, an mDL may be configured to store and/or point to the public key information associated with the IA from which the mDL was provisioned. Additional details related to the execution of various operations related to one or more mDLs associated with a user by the smart mobile wallet management system 102 will be described in greater detail herein with reference to FIGS. 2-5.

In some embodiments, the smart mobile wallet management system 102 further comprises and/or integrates with a storage device that comprises a distinct component from other components of the smart mobile wallet management system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Additionally or alternatively, the storage device may host the software executed to operate the smart mobile wallet management system 102. Additionally or alternatively, the storage device may store information relied upon during operation of the smart mobile wallet management system 102, such as various user data (e.g., user attribute data, user identification data), mDL data (e.g., cryptographic information, credential information), enterprise data (e.g., payment account data, user transaction data, product and/or service data), smart mobile wallet data (e.g., payment account data, payment card data, and/or the like associated with a user), distribution data, logistical data, legal data, software application framework data), data related to verification-required transaction items (e.g., restricted items, financial transactions, loan disbursements, credit applications, visa applications, permit applications) with detailed verification requirements (e.g., age, identity, other documentations), and/or the like configured in various data formats to be utilized by the smart mobile wallet management system 102. In addition, the storage device may store control signals, device characteristics, and/or access credentials enabling interaction between the smart mobile wallet management system 102 and/or one or more of the enterprise computing devices 106A-106N or user devices 108A-108N.

In various embodiments, the one or more enterprise computing devices 106A-106N and/or the one or more user devices 108A-108N may be embodied by any computing devices known in the art. The one or more enterprise computing devices 106A-106N and/or the one or more user devices 108A-108N need not themselves be independent devices but may be peripheral devices communicatively coupled to other computing devices.

### Example Implementing Apparatuses

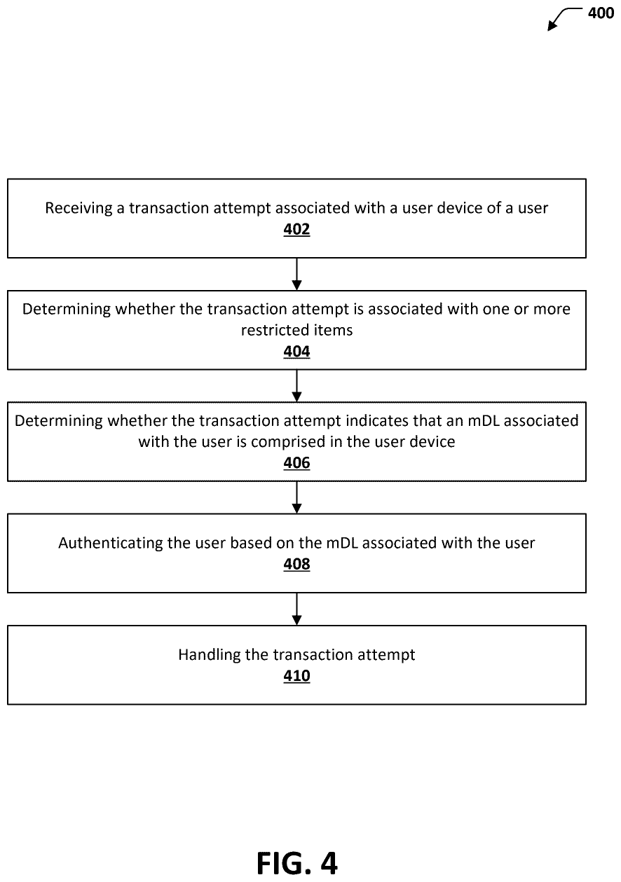

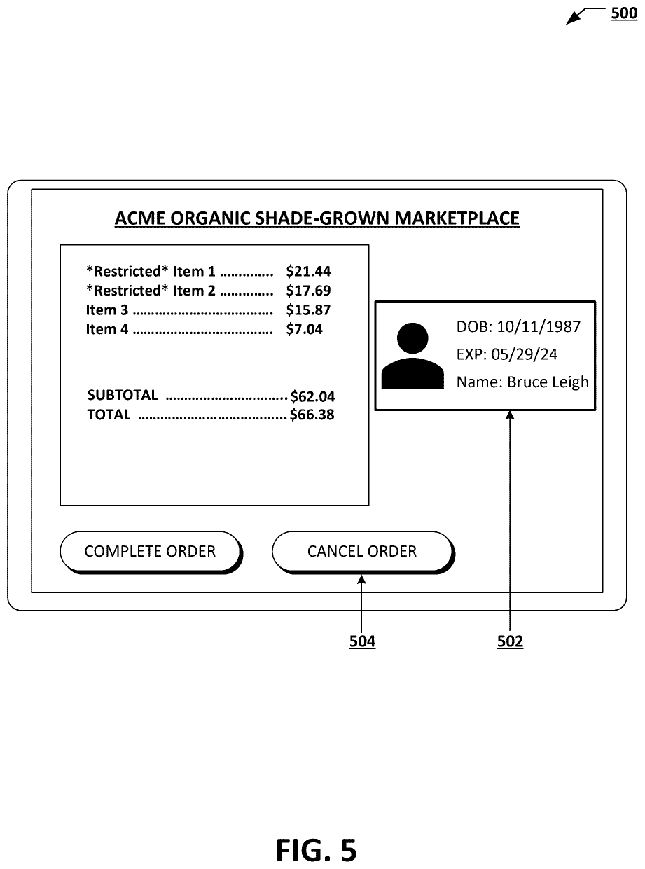

The smart mobile wallet management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-5. As illustrated in FIG. 2, the apparatus 200 may include processor 202, memory 204, communications hardware 206, mDL management circuitry 208, user authentication circuitry 210, smart mobile wallet management circuitry 212, and biometric data management circuitry 214, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204, the storage device, or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

The memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, and/or the like for enabling the apparatus 200 to conduct various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application instance (e.g., a mobile application), dedicated client device, or the like. In some embodiments, the communications hardware 206 may include a keyboard, a mouse, a touch screen, touch areas, soft keys, a microphone, a camera, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises mDL management circuitry 208. In some embodiments, the mDL management circuitry 208 may be configured to facilitate the execution of one or more mDL authentication and/or IA authentication operations for an enterprise associated with the smart mobile wallet management system 102. Additionally, the mDL management circuitry 208 may utilize processor 202, memory 204, or any other hardware component included in the apparatus 200 to perform these operations, as described in connection with FIGS. 4-5 below. The mDL management circuitry 208 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the mDL management circuitry 208 may work in conjunction with the user authentication circuitry 210, the smart mobile wallet management circuitry 212, and/or the biometric data management circuitry 214 in order to execute one or more of the methods described herein. For example, in some embodiments, the mDL management circuitry 208 may integrate with and/or otherwise leverage the user authentication circuitry 210 to facilitate the authentication of a user based on a respective mDL associated with the user.

In various circumstances, an IA system (e.g., IA system 110A) that previously issued an mDL to a respective user may periodically update credential data associated with the mDL (e.g., new user contact information, updated credential restrictions, updated credential endorsements). As such, the mDL management circuitry 208 may be configured to retrieve and/or receive updated credential data associated with a user's mDL from an IA system (e.g., IA system 110A) and facilitate the updating of the user's mDL based on the updated credential data. For example, if an mDL associated with a user is stored in a smart mobile wallet being managed by the smart mobile wallet management system 102, the mDL management circuitry 208 may be configured to receive updated credential data associated with the user's mDL from the originating IA system (e.g., IA system 110A) and subsequently update the user's mDL in the smart mobile wallet based on the updated credential data.

In some embodiments, the mDL management circuitry 208 may work in conjunction with the smart mobile wallet management circuitry 212 in order to update an mDL stored in a smart mobile wallet stored on a user device (e.g., user device 108A). In such embodiments, the mDL management circuitry 208 may be configured to query one or more storage devices (e.g., server systems) associated with an IA system (e.g., IA system 110A) in order to retrieve current and/or updated credential data in response to one or more interactions with a user interface associated with the smart mobile wallet. Additionally or alternatively, the mDL management circuitry 208 may be configured to periodically query to one or more storage devices (e.g., server systems) associated with an IA system (e.g., IA system 110A) based on a predefined schedule (e.g., once a day, once a week, once a month, once every 90 days) in order to retrieve current and/or updated credential data associated with a user' mDL.

In various examples, an IA (e.g., a branch of the DMV) associated with a respective IA system (e.g., IA system 110A) may enforce various mDL data freshness requirements associated with the mDLs the IA system provisions to users. In this regard, an MSO associated with a respective mDL may indicate a technical validity period associated with the mDL (e.g., a 30-day validity period). As such, the mDL management circuitry 208 may utilize the technical validity period indicated by the MSO to ensure that the credential data associated with the mDL stored on a user device (e.g., user device 108A) is updated and/or current. For example, if the mDL management circuitry 208 determines that the technical validity period indicated by the MSO has expired, the mDL may be invalidated until the credential data associated with the mDL is refreshed (e.g., updated, verified) by the IA system 110A associated with the IA from which the mDL was issued. In some examples, the technical validity period of the mDL indicated by the MSO may be shorter than a validity period of the mDL and/or the corresponding physical legal credential associated with the mDL (e.g., an expiration date of a driver's license associated with the mDL).

For example, legal credentials (e.g., a driver's license and/or the corresponding mDL) are commonly associated with a relatively long validity period (e.g., five to seven years from the date of issue of the legal credential). However, problems may arise if an IA assigns various credential restrictions (e.g., driving restrictions) and/or credential endorsements (e.g., weighted vehicle endorsements) to a particular user's legal credential, yet the user fails to have the legal credential (e.g., a corresponding physical credential) updated with said credential restrictions and/or credential endorsements. To address such problems, if the mDL management circuitry 208 determines that the technical validity period indicated by the MSO of the mDL has expired, the corresponding mDL may flag the mDL such that the mDL will fail various authentication protocols during an mDL-based transaction.

In this regard, the mDL management circuitry 208 may be configured to facilitate the resetting of the technical validity period indicated by the MSO of the mDL in conjunction with a corresponding IA system (e.g., IA system 110A). Additionally or alternatively, the mDL management circuitry 208 may be configured to facilitate the updating and/or verification of the credential data associated with an mDL stored on a user device (e.g., user device 108A) each time the technical validity period associated with the MSO of the mDL is reset. This mDL data security mechanism ensures that the credential data associated with a user's mDL is always accurate and up to date.

As described herein, an mDL may be associated with various cryptographic key information (e.g., public/private key pair information) that may be utilized by the smart mobile wallet management system 102 to authenticate an originating IA that issued the mDL, verify one or more portions of credential data associated with an mDL, and/or facilitate various mDL-based transactions (e.g., retail purchase transactions, user authentication protocols, mDL data queries) for a user associated with the mDL. In this regard, the mDL management circuitry 208 may be configured to generate and/or transmit an IA authentication request comprising a public key associated with an IA to a corresponding IA system 110A in order to verify that a particular mDL was indeed provisioned by the IA associated with the IA system 110A.

In some examples, an mDL may only comprise (e.g., store, point to) identifying information related to a particular IA such that the mDL management circuitry 208 may be configured to first obtain a public key associated with the IA from a corresponding IA system 110A based on the identifying information. Once the public key information associated with the IA is obtained, the mDL management circuitry 208 may be configured to generate an IA authentication request comprising the public key of the IA and transmit the IA authentication request to the IA system 110A (e.g., via the communications network 104). As such, the mDL management circuitry 208 may be configured to receive, from an IA system (e.g., IA system 110A) and in response to the IA authentication request, one or more portions of data indicating whether the IA is a bona fide IA and/or whether the mDL indeed originated from the IA.

Once the mDL management circuitry 208 confirms the validity of the IA and/or confirms that a particular mDL associated with a user originated from the IA, the mDL management circuitry 208 may be configured to generate a digital token comprising cryptographic information (e.g., public key information) associated with the mDL and the user. Additionally, in some embodiments, the cryptographic information associated with the mDL and comprised in the digital token may be user device identification data by which a user device (e.g., user device 108A) of the respective user may be uniquely identified. In various examples, the mDL management circuitry 208 may generate and/or transmit the digital token to an IA system (e.g., IA system 110A) such that the IA system may decrypt the cryptographic information comprised in the digital token. In this manner, the IA system (e.g., IA system 110A) may authenticate (e.g., verify) one or more portions of credential data associated with the mDL and/or one or more portions of user device identification data associated with the user device (e.g., user device 108A). In this regard, the mDL management circuitry 208 may be configured to receive, from the IA system (e.g., IA system 110A) and in response to transmitting the digital token, one or more portions of data indicating whether the mDL and/or the user device (e.g., user device 108A) identified by the digital token is valid. Furthermore, in various examples, the mDL management circuitry 208 may be configured to receive, from the IA system (e.g., IA system 110A) and in response to transmitting the digital token, one or more portions of credential data associated with the mDL.

In some embodiments, the mDL management circuitry 208 may be configured to generate a digital token comprising cryptographic information (e.g., public key information) associated with an mDL and/or a user device (e.g., user device 108A) associated with a particular user in response to an mDL authentication request associated with the particular user. In some embodiments, the mDL authentication request may be a request to authenticate an mDL associated with the particular user and thereby authenticate the identity of the particular user for one or more mDL-based transactions. A respective mDL authentication request may comprise one or more of cryptographic information (e.g., public key information) associated with an mDL and/or a user device (e.g., user device 108A). Additionally or alternatively, a respective mDL authentication request may comprise one or more desired data elements (e.g., one or more portions of desired credential data) associated with the mDL, location data, user profile data, user account data, social media data, smart mobile wallet identification data, user device identification data, and/or the like associated with the particular user. In various examples, the mDL authentication request may be associated with a user associated with a payment account and may be triggered based on a determination made by the smart mobile wallet management system 102 that a transaction attempt is associated with one or more restricted items (e.g., alcohol, tobacco products, firearms, prescription medications, hazardous materials, controlled substances, and/or the like), a mobile check deposit, a disbursement payment claim, and/or the like.

In various examples, an mDL validity response received from an IA system (e.g., IA system 110A) based on a digital token generated by the mDL management circuitry 208 may comprise the entirety of the credential data associated with the mDL of the particular user. Additionally or alternatively, in various other examples, an mDL validity response received from an IA system (e.g., IA system 110A) based on a digital token generated by the mDL management circuitry 208 may comprise a verification of the desired credential data associated with the mDL that was indicated by an mDL authentication request. Additionally or alternatively, in various other examples, an mDL validity response received from an IA system (e.g., IA system 110A) based on a digital token generated by the mDL management circuitry 208 may comprise a verification of the user device identification data associated with the user device (e.g., user device 108A) of the particular user. For example, the mDL validity response may verify that the user device currently associated with the mDL is the same (e.g., intended) user device that the mDL was originally provisioned to. In this manner, the smart mobile wallet management system 102 may be configured to confirm the validity of the mDL data of an mDL associated with a particular user in order to authenticate the identity of the particular user. Additionally, this enables the smart mobile wallet management system 102 to confirm whether the intended user and/or user device (e.g., user device 108A) associated with the mDL is currently in possession of the mDL. These and other operations associated with the mDL management circuitry 208 will be described in further detail herein below with reference to FIGS. 4-5.

In addition, the apparatus 200 further comprises user authentication circuitry 210. In some embodiments, the user authentication circuitry 210 may be configured to facilitate the execution of one or more user authentication operations for an enterprise associated with the smart mobile wallet management system 102. Additionally, the user authentication circuitry 210 may utilize processor 202, memory 204, to perform these operations, as described in connection with FIGS. 4-5 below. The user authentication circuitry 210 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the user authentication circuitry 210 may work in conjunction with the mDL management circuitry 208, the smart mobile wallet management circuitry 212, and/or the biometric data management circuitry 214 in order to execute one or more of the methods described herein. For example, in some embodiments, the user authentication circuitry 210 may integrate with and/or otherwise leverage the mDL management circuitry 208 to facilitate the identification and/or authentication of a user based on a respective mDL associated with the user. As another example, in some embodiments, the user authentication circuitry 210 may integrate with and/or otherwise leverage the biometric data management circuitry 214 to facilitate the identification and/or authentication of a user based on captured biometric data and/or known biometric data associated with the user.

Additionally, the user authentication circuitry 210 may be configured to identify a smart mobile wallet associated with a respective user. For example, the user authentication circuitry 210 may identify a smart mobile wallet associated with a user based on attribute data associated with the user. In some embodiments, user attribute data associated with a respective user may comprise user profile data, payment account data, user contact data, social media data, location data, and/or smart mobile wallet identification data associated with the respective user. In various examples, once the user authentication circuitry 210 identifies a smart mobile wallet that is associated with the respective user, the user authentication circuitry 210 may be configured to generate a user identification data request based on user attribute data associated with the respective user. The user authentication circuitry 210 may be configured to leverage the communications hardware 206 to transmit the user identification data request to the smart mobile wallet ostensibly associated with the respective user. Furthermore, the user authentication circuitry 210 may be configured to leverage the communications hardware 206 to receive user identification data from the smart mobile wallet ostensibly associated with the respective user based on the user identification data request.

In various examples, the user identification data associated with a respective user comprises cryptographic information associated with one or more of an mDL and/or a user device (e.g., user device 108A) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the smart mobile wallet management system 102 and/or an IA system (e.g., IA system 110A) associated with the IA that provisioned the mDL to identify and/or authenticate the mDL, one or more portions of desired mDL credential data, and/or the user device associated with the respective user. In this regard, the user authentication circuitry 210 may be configured to verify that the smart wallet ostensibly associated with the respective user is indeed associated with the respective user and that the smart mobile wallet management circuitry 212 may safely transmit and/or receive data (e.g., payment account data, transaction data) to and/or from the smart mobile wallet associated with the respective user. These and other operations associated with the user authentication circuitry 210 will be described in further detail herein below with reference to FIGS. 4-5.

In addition, the apparatus 200 further comprises smart mobile wallet management circuitry 212. In some embodiments, the smart mobile wallet management circuitry 212 may be configured to facilitate the execution of one or more smart mobile wallet operations and/or transactions for an enterprise associated with the smart mobile wallet management system 102. Additionally, the smart mobile wallet management circuitry 212 may utilize processor 202, memory 204, to perform these operations, as described in connection with FIGS. 4-5 below. The smart mobile wallet management circuitry 212 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the smart mobile wallet management circuitry 212 may work in conjunction with the mDL management circuitry 208, the user authentication circuitry 210, and/or the biometric data management circuitry 214 in order to execute one or more of the methods described herein.

For example, in some embodiments, the smart mobile wallet management circuitry 212 may integrate with and/or otherwise leverage the user authentication circuitry 210 to facilitate the identification and/or authentication of a user in order to determine whether to allow or deny a transaction attempt associated with a respective payment account (e.g., a payment account associated with a smart mobile wallet). In this regard, the smart mobile wallet management circuitry 212 may be configured to determine whether a respective transaction attempt is associated with one or more restricted items (e.g., alcohol, tobacco products, firearms, prescription medications, hazardous materials, controlled substances, and/or the like). In an instance in which a transaction attempt is associated with one or more restricted items, the smart mobile wallet management circuitry 212 may be configured to determine whether the transaction attempt indicates that an mDL associated with the user is comprised in a user device (e.g., user device 108A) and/or a smart mobile wallet associated with the user. In response to determining that the transaction attempt indicates an mDL associated with the user is comprised in the user device (e.g., user device 108A) and/or the smart mobile wallet, the smart mobile wallet management circuitry 212 may be configured to leverage the user authentication circuitry 210 to authenticate the user based on the on the mDL associated with the user.

Additionally, the smart mobile wallet management circuitry 212 may be configured to leverage the processor 202, the memory 204, and/or the communications hardware 206 to generate, cause transmission of, and/or cause display of a plurality of interactive user interface elements on a user interface associated with a software application instance associated with the smart mobile wallet management system 102 on a user device associated with a user (e.g., user device 108A). The plurality of interactive user interface elements may be configured as one or more interactive text fields, buttons, selectable images, hyperlinks, radio buttons, sliders, embedded multimedia modules, charts, graphs, prompts, notifications, banners, instructions, and/or the like configured to initiate execution of one or more commands (e.g., executable software instructions) based on an interaction (e.g., user input) with the plurality of interactive user interface elements.

Additionally or alternatively, the smart mobile wallet management circuitry 212 may be configured to leverage the processor 202, the memory 204, and/or the communications hardware 206 to generate and/or configure (e.g., instantiate, update) a smart mobile wallet comprising one or more of a plurality of interactive user interface elements. The smart mobile wallet management circuitry 212 may generate a smart mobile wallet for a respective user based on one or more user attributes associated with the respective user and/or enterprise data corresponding to the respective user stored by the enterprise associated with the smart mobile wallet management system 102. Additionally, the smart mobile wallet management circuitry 212 may be configured to leverage the processor 202, the memory 204, and/or the communications hardware 206 to provide the smart mobile wallet to a user device (e.g., user device 108A) associated with the respective user such that the respective user is enabled to interact with and/or utilize the smart mobile wallet to execute various operations, transactions, and/or the like.

For example, based on one or more interactions with a respective smart mobile wallet, the smart mobile wallet management circuitry 212 may be configured to facilitate one or more financial transactions for a respective user. The one or more financial transactions may involve the settlement of a payment (e.g., the withdrawal and transfer of funds) initiated by a respective user with a particular merchant (e.g., an online merchant, a brick-and-mortar retailer). In this regard, the smart mobile wallet management circuitry 212 may be configured to utilize account data (e.g., user account identifier information, user account routing information, and/or the like) associated with one or more means of payment (e.g., a payment card, payment account routing information) stored in and/or associated with a smart mobile wallet of a respective user to ensure an appropriate amount of funds is transferred from the respective user to the merchant.

In this regard, the smart mobile wallet management circuitry 212 may be configured to determine whether a payment account is linked to a smart mobile wallet associated with the user. In an instance in which the payment account is not linked to the smart mobile wallet, the smart mobile wallet management circuitry 212 may be configured to leverage the communications hardware 206 to receive, retrieve, and/or otherwise obtain payment account data associated with the payment account from a user device (e.g., user device 108A) associated with the user. In some examples, the payment account data may comprise one or more of an account identifier, card number, account number, card verification value (CVV), user account information (e.g., username, password), and/or the like. Once the payment account data is acquired, the smart mobile wallet management circuitry 212 may be configured to link the payment account to the smart mobile wallet such that one or more transaction attempts associated with the payment account may be facilitated via the smart mobile wallet.

Additionally or alternatively, in various examples, the smart mobile wallet management circuitry 212 may be configured to facilitate the transfer of disbursement payments (e.g., payments related to a personal loan, a loan offered based on a government initiative (e.g., an economic injury disaster loan (EIDL), a paycheck protection program (PPP) loan), and/or the like), facilitate mobile check deposits, and/or the like. In this regard, the smart mobile wallet management circuitry 212 may be configured to determine whether a respective transaction attempt is associated with a disbursement payment claim attempt associated with the user. For example, the smart mobile wallet management circuitry 212 may be configured to determine whether a user is attempting to apply for, claim, and/or otherwise obtain a disbursement payment. In response to determining that a respective transaction attempt is associated with the disbursement payment claim attempt, the smart mobile wallet management circuitry 212 may be configured to leverage the user authentication circuitry 210 to authenticate the user based on the mDL associated with the user (e.g., comprised in the smart mobile wallet of the user).

Based on the result of the mDL-based user authentication, the smart mobile wallet management circuitry 212 may be configured to allow (e.g., enable, permit, facilitate payment) or deny (e.g., cancel, terminate, halt) the disbursement payment claim attempt. In some examples, the smart mobile wallet management circuitry 212 may be configured to generate and/or cause transmission of a notification indicating a successful mDL-based user authentication to one or more computing devices associated with one or more agencies, enterprises, and/or authoritative entities. Such a notification may be utilized by the one or more agencies, enterprises, and/or authoritative entities in order to trigger, approve, and/or otherwise initiate the release of the disbursement payments to a payment account associated with the user.

Additionally or alternatively, in some examples, the smart mobile wallet management circuitry 212 may be configured to determine whether a respective transaction attempt is associated with a mobile check deposit attempt. For example, the smart mobile wallet management system 102 may be configured to enable a smart mobile wallet associated with a user to facilitate the remote depositing of physical checks (e.g., personal checks, certified checks) into a payment account associated with the smart mobile wallet. Alternatively, the smart mobile wallet management system 102 may be configured to enable a user to utilize a software application instance associated with the smart mobile wallet management system 102 to remotely deposit physical checks (e.g., personal checks, certified checks) into a payment account associated with the user.

As such, in response to determining that a respective transaction attempt is associated with a mobile check deposit attempt, the smart mobile wallet management circuitry 212 may be configured to compare various check data (e.g., user name, user address, user account number, user routing number, user endorsement signature, monetary amount, memo line information, and/or the like) related to a check (e.g., personal check, certified check) and/or destination payment account associated with the mobile check deposit attempt to mDL data associated with the mDL associated with the user. The smart mobile wallet management circuitry 212 may be configured to generate a check data matching score based on matching the user signature data captured in real time, or near-real time, to the known user signature data associated with the user's mDL. In some examples, the more check data associated with the check related to a mobile check deposit attempt that matches the mDL associated with a user's mDL, the higher the check data matching score may be.

Accordingly, the smart mobile wallet management circuitry 212 may be configured to determine if a check data matching score (e.g., a numerical value or the like) satisfies a respective check data matching threshold (e.g., a numerical value or the like). The check data matching score may satisfy the respective check data matching threshold if the check data matching score is greater than or equal to the respective check data matching threshold (e.g., to within an error value of ±1%, ±5%, or any other number). In other examples, the check data matching score (e.g., a numerical value or the like) may satisfy the respective check data matching threshold (e.g., a numerical value or the like) if the check data matching score is less than or equal to the respective check data matching threshold (e.g., to within an error value of ±1%, ±5%, or any other number). In response to determining whether the check data satisfies the check data matching threshold, the smart mobile wallet management circuitry 212 may be configured to allow (e.g., enable, permit, facilitate check deposit) or deny (e.g., cancel, terminate, halt) the mobile check deposit attempt.

Additionally, in various examples, the smart mobile wallet management circuitry 212 may be configured to compare various mDL data associated with a user's mDL to data associated with supplemental required documentation that may be necessary to execute various transaction attempts. In some examples, the supplemental required documentation may be provided to the user by an authoritative entity (e.g., a government agency, licensed entity, medical professional, and/or the like) and may indicate that the user is eligible to purchase, rent, claim, occupy, utilize, and/or otherwise access restricted and/or identity verification-dependent items or spaces. Examples of the supplemental required documentation may include, but are not limited to, restricted item purchase permits (e.g., firearm permits, hazardous material permits, hazardous chemical permits, and/or any relevant permit required to purchase a restricted item), usage permits (e.g., permits to use public spaces and/or public roads, event permits, protest permits, construction permits, and/or the like), medical prescription documentation, application documentation (e.g., loan application documentation, permit application documentation, and/or the like), and/or any relevant documentation required to purchase, rent, claim, occupy, utilize, and/or otherwise access restricted and/or identity verification-dependent items or spaces. The results of the comparison of the mDL data associated with the user to the data associated with the supplemental required documentation may be utilized by the smart mobile wallet management circuitry 212 to verify that the supplemental required documentation is indeed associated with the user and that the user is the intended recipient of the supplemental required documentation and/or any restricted and/or identity verification-dependent items or spaces associated with the supplemental required documentation.

Additionally, in various embodiments, the smart mobile wallet management circuitry 212 may be configured to generate and cause storage of an audit trail associated with a user in a storage device associated with the smart mobile wallet management system 102. In some examples, an audit trail may be associated with a discrete transaction attempt. In various other examples, an audit trail may be associated with one or more transaction attempts associated with a specific user. An audit trail may be an electronically managed data structure that comprises data related to one or more items (e.g., restricted items), disbursement payment claims, mobile check deposits, supplemental required documentation, and/or the like associated with a respective transaction attempt. Furthermore, an audit trail may indicate various mDL data (e.g., desired credential data) associated with an mDL of a respective user that was utilized during a respective transaction attempt for one or more user authentication and/or verification processes.

In some examples, an audit trail may be generated by the smart mobile wallet management circuitry 212 in response to the allowance or denial of a respective transaction attempt. As such, an audit trail may indicate information related to the success or failure of an authentication or verification of one or more entities involved in a respective transaction attempt (e.g., one or more of a user and/or a merchant, distributer, certified professional, and/or the like). Furthermore, an audit trail may indicate one or more payment methods and/or payment accounts utilized during the transaction attempt. Additionally or alternatively, the audit trail may comprise identification information related to a user device (e.g., user device 108A) and/or a smart mobile wallet associated with a user that was utilized during the respective transaction attempt. In this manner, the smart mobile wallet management circuitry 212 may be configured to track, document, and/or cause the storage of various data related to one or more transaction attempts, disbursement payment claim attempts, and/or mobile check deposits executed by a respective user. These and other operations associated with the smart mobile wallet management circuitry 212 will be described in further detail herein below with reference to FIGS. 4-5.

In addition, the apparatus 200 further comprises biometric data management circuitry 214. In some embodiments, the biometric data management circuitry 214 may be configured to facilitate the execution of one or more biometric data capture and/or analysis processes for an enterprise associated with the smart mobile wallet management system 102. Additionally, the biometric data management circuitry 214 may utilize processor 202, and/or memory 204, to perform these operations, as described in connection with FIGS. 4-5 below. The biometric data management circuitry 214 may further utilize the communications hardware 206 to gather data from, or transmit data to, a variety of sources (e.g., the enterprise computing devices 106A-106N, the user devices 108A-108N, the IA systems 110A-110N, and/or any storage devices associated with the smart mobile wallet management system 102), and/or exchange data with a user. In some embodiments, the biometric data management circuitry 214 may work in conjunction with the mDL management circuitry 208, the user authentication circuitry 210, and/or the smart mobile wallet management circuitry 212 in order to execute one or more of the methods described herein. For example, in some embodiments, the biometric data management circuitry 214 may integrate with and/or otherwise leverage the user authentication circuitry 210 and/or the mDL management circuitry 208 to facilitate the identification and/or authentication based in part on the biometric data associated with a user in order to determine whether to allow or deny a transaction attempt associated with the user.

In some examples, the biometric data management circuitry 214 may comprise, embody, and/or otherwise integrate with various biometric data capture hardware components including image capture devices (e.g., video cameras, photographic cameras), audio capture devices (e.g., microphones, voice samplers), biometric data capture devices (e.g., fingerprint capture devices, palm print capture devices) and/or the like that are configured to capture various biometric data associated with a respective user (e.g., image data related to a user's body features (e.g., facial features, eye features, body posture, gait), fingerprint geometry, palm print geometry, voice and/or speech data, user signature data, and/or the like). Additionally or alternatively, the biometric data management circuitry 214 may be configured to embody and/or integrate with a security system associated with a respective merchant (e.g., a closed-circuit television (CCTV) system, biometric data capture system, alarm system, and/or the like) such that the biometric data management circuitry 214 may utilize any biometric data associated with a user that is captured by the security system associated with the respective merchant.

In this regard, the biometric data management circuitry 214 may be configured to capture and/or facilitate the capture of biometric data associated with a respective user. Additionally, the biometric data management circuitry 214 may be configured to compare captured biometric data associated with a user to known biometric data associated with the user (e.g., biometric data associated with the user that has been previously verified, analyzed, and/or or stored in a storage device associated with the smart mobile wallet management system 102). Furthermore, in some examples, the known biometric data may be associated with an mDL associated with the user (e.g., user portrait image data, user signature data, and/or the like associated with the user's mDL).

The biometric data management circuitry 214 may be configured to determine, based on comparing the captured biometric data to the known biometric data, whether the biometric data satisfies a biometric data matching threshold. For example, the biometric data management circuitry 214 may be configured to employ one or more facial recognition techniques to authenticate a user during a transaction attempt. The biometric data management circuitry 214 may be configured to authenticate a respective user by matching image data related to the respective user's face that is captured in real time, or near-real time, during a transaction attempt (e.g., via a camera of a user device 108A, via a security system associated with a merchant) to user portrait image data associated with an mDL related to the respective user. As such, the biometric data management circuitry 214 may be configured to generate a biometric data matching score based on matching the image data of the user's face captured in real time, or near-real time, to the user portrait image data associated with the user's mDL.

As another example, the biometric data management circuitry 214 may be configured to employ one or more handwriting recognition techniques to authenticate a user during a transaction attempt. The biometric data management circuitry 214 may be configured to authenticate a respective user by matching user signature data that is captured in real time, or near-real time, during a transaction attempt (e.g., via a handwriting capture device) to known user signature data associated with an mDL related to the respective user. As such, the biometric data management circuitry 214 may be configured to generate a biometric data matching score based on matching the user signature data captured in real time, or near-real time, to the known user signature data associated with the user's mDL.

Accordingly, the biometric data management circuitry 214 may be configured to determine if a biometric data matching score (e.g., a numerical value or the like) satisfies a respective biometric data matching threshold (e.g., a numerical value or the like). The biometric data matching score may satisfy the respective biometric data matching threshold if the biometric data matching score is greater than or equal to the respective biometric data matching threshold (e.g., to within an error value of ±1%, ±5%, or any other number). In other examples, the biometric data matching score (e.g., a numerical value or the like) may satisfy the respective biometric data matching threshold (e.g., a numerical value or the like) if the biometric data matching score is less than or equal to the respective biometric data matching threshold (e.g., to within an error value of ±1%, ±5%, or any other number).

As such, the biometric data management circuitry 214 may facilitate various biometric authentication techniques in order to authenticate a respective user before allowing or denying a respective transaction attempt. In some examples, the known biometric data associated with the user need not be associated with the mDL of the user. In such examples, the biometric data management circuitry 214 may be configured to facilitate the execution of biometric authentication including one or more of facial recognition, voice recognition, and/or various other biometric authentication techniques (e.g., fingerprint recognition, retina recognition, iris recognition, voice recognition) in order to determine whether to allow or deny a respective transaction attempt.

Although components 202-214 are described in part using functional language, it will be understood that the particular implementations necessarily include the use of particular hardware. It should also be understood that certain of these components 202-214 may include similar or common hardware. For example, the mDL management circuitry 208, the user authentication circuitry 210, the smart mobile wallet management circuitry 212, and/or the biometric data management circuitry 214 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may, in addition, refer to software instructions that configure the hardware components of the apparatus 200 to perform the various functions described herein.

Although the mDL management circuitry 208, the user authentication circuitry 210, the smart mobile wallet management circuitry 212, and/or the biometric data management circuitry 214 may leverage processor 202, memory 204, and/or communications hardware 206 as described above, it will be understood that any of the mDL management circuitry 208, the user authentication circuitry 210, the smart mobile wallet management circuitry 212, and/or the biometric data management circuitry 214 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that the mDL management circuitry 208, the user authentication circuitry 210, the smart mobile wallet management circuitry 212, and/or the biometric data management circuitry 214 comprise particular machinery designed for performing the functions described herein in connection with such elements of apparatus 200.

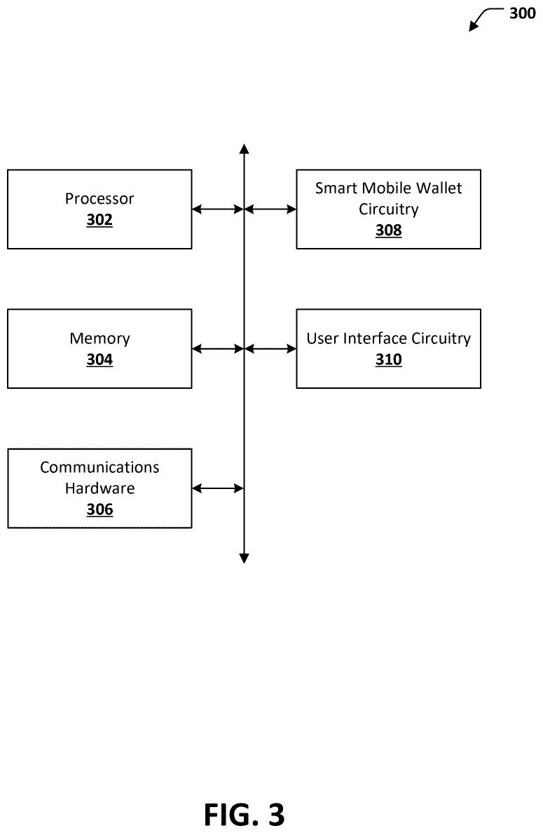

As illustrated in FIG. 3, an apparatus 300 is shown that represents an example enterprise computing device (e.g., any of enterprise computing devices 106A-106N) or an example user device (e.g., any of user devices 108A-108N). The apparatus 300 includes processor 302, memory 304, and communications hardware 306, each of which is configured to be similar to the similarly named components described above in connection with FIG. 2. Additionally, the apparatus 300 may also include smart mobile wallet circuitry 308, and/or user interface circuitry 310, each of which may be configured to facilitate the execution of the various methods described herein. For example, the smart mobile wallet circuitry 308, and/or the user interface circuitry 310 may be configured to work in conjunction to facilitate user interaction with the smart mobile wallet management system 102. Furthermore, the smart mobile wallet circuitry 308 may be configured to manage and/or facilitate one or more actions related to a smart mobile wallet associated with a respective user on a user device (e.g., user device 108A) that has been provisioned by the smart mobile wallet management system 102. In some embodiments, the smart mobile wallet circuitry 308 may utilize processor 302, memory 304, or any other hardware component included in the apparatus 300 to perform one or more of the operations described in connection with FIGS. 4-5 below.

In some embodiments, the smart mobile wallet circuitry 308 includes hardware components designed for generating one or more requests configured to initiate various operations to be executed by the smart mobile wallet management system 102. For example, the smart mobile wallet circuitry 308 may be configured to facilitate the execution of various transaction attempts (e.g., in-store or online transaction attempts) associated with various items including restricted items (e.g., alcohol, tobacco products, firearms, prescription medications, hazardous materials, controlled substances, and/or the like), mobile check deposits, disbursement payment claims, and/or the like.

In various examples, the execution of various transaction attempts by the smart mobile wallet circuitry 308 may initiate the transmission and/or execution of one or more mDL authentication requests associated with a respective user. The one or more mDL authentication requests may be requests to verify and/or authenticate the respective user based on a corresponding mDL. For example, as described herein, the smart mobile wallet management system 102 may be configured to generate and/or transmit user identification data requests (e.g., user identification data requests, user identification data requests, and/or the like) to respective smart mobile wallets to facilitate the one or more operations described herein. As such, the smart mobile wallet circuitry 308 may be configured to generate and/or cause transmission of a response providing user identification data comprised in and/or associated with a smart mobile wallet on the user device (e.g., user device 108A).

As described herein, the user identification data associated with a respective user may comprise cryptographic information associated with one or more of an mDL and/or a user device (e.g., user device 108A) associated with the respective user. In some embodiments the cryptographic information associated with the mDL and/or the user device may be a public key of a public/private key pair, where the public key is provisioned to the respective user by an IA upon issuance of the mDL. Such cryptographic information may be utilized by the smart mobile wallet management system 102 and/or an IA system (e.g., IA system 110A) associated with the IA that provisioned the mDL to identify and/or authenticate the mDL, one or more portions of desired mDL credential data, and/or the user device associated with the respective user.

Additionally, the smart mobile wallet circuitry 308 may be configured to facilitate various actions associated with one or more payment methods associated with a smart mobile wallet on a respective user device (e.g., user device 108A). For example, the smart mobile wallet circuitry 308 may be configured to facilitate the management of, utilization of, and/or interaction with one or more of a payment card (e.g., a credit card, debit card), payment account (e.g., checking account, savings account), and/or user account affiliated with an enterprise (e.g., financial institution) associated with the smart mobile wallet management system 102. For instance, in some embodiments, the smart mobile wallet circuitry 308 may be configured to enable a user to check an account balance, view historical transactions, initiate a payment transaction, stop a payment transaction, transfer funds, link a payment account or method, unlink a payment account or method, settle a payment transaction at a POS associated with a merchant, settle an online payment transaction, and/or the like via the smart mobile wallet on a respective user device (e.g., user device 108A).

Furthermore, the smart mobile wallet circuitry 308 may be configured to facilitate various actions associated with an mDL of a respective user that is stored in and/or associated with the smart mobile wallet on a respective user device (e.g., user device 108A). For example, the smart mobile wallet circuitry 308 may be configured to cause an mDL to be updated, verified, authenticated and/or deleted from the smart mobile wallet. In some embodiments, the smart mobile wallet circuitry 308 may be configured to leverage the communications hardware 306 to communicate with an IA system (e.g., IA system 110A) in order to retrieve and/or receive one or more portions of mDL data (e.g., updated credential data) associated with an mDL stored in the smart mobile wallet. Additionally or alternatively, the smart mobile wallet circuitry 308 may be configured to leverage the communications hardware 306 to cause one or more components of the apparatus 200 (e.g., the mDL management circuitry 208) to facilitate the update of an mDL stored in a smart mobile wallet of a respective user device (e.g., user device 108A).

In addition, the apparatus 300 may also include the user interface circuitry 310, which includes hardware components designed for receiving user inputs and/or rendering virtual graphics outputs. The user interface circuitry 310 may utilize processor 302, memory 304, or any other hardware component included in, or integrated with, the apparatus 300 to perform these operations, as described in connection with FIGS. 4-5 below. The user interface circuitry 310 may further utilize communications hardware 306 to transmit data representative of a user input and/or receive data to render as a virtual graphics output or may otherwise utilize processor 302 and/or memory 304 to generate data representative of a user input and/or generate virtual graphics output, e.g., from based on received data. The user interface circuitry 310 may comprise one or more of a keyboard, pointing device, touchscreen, microphone with speech recognition interface, one or more cameras, and/or one or more other input devices capable of receiving various different user inputs. In addition, the user interface circuitry 310 may comprise a display device including one or more of a screen with graphical user interface (GUI), speaker, light-emitting diode (LED) display, organic LED (OLED) display, LCD display, touchscreen, haptic technology device, and/or other output device capable of rendering information to a user.

Additionally, the user interface circuitry 310 may utilize processor 302, memory 304, smart mobile wallet circuitry 308, or any other hardware component included in, or integrated with, the apparatus 300 to run, host, configure, and/or otherwise execute one or more operations, instructions, and/or commands related to a software application instance and/or smart mobile wallet associated with the smart mobile wallet management system 102. For example, the user interface circuitry 310 may be configured allow a user to interact with the smart mobile wallet management system 102 via the software application instance in order to facilitate one or more transaction attempts, mobile check deposits, disbursement payment claim attempts, smart mobile wallet operations, user authentication operations, and/or any of the other methods described herein.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of flowcharts.

### EXAMPLE OPERATIONS

Turning to FIG. 4, example flowcharts are illustrated that contain example operations implemented by example embodiments described herein. The operations illustrated in FIG. 4 may, for example, be performed by a system device (e.g., server) of the smart mobile wallet management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, mDL management circuitry 208, user authentication circuitry 210, smart mobile wallet management circuitry 212, biometric data management circuitry 214, and/or any combination thereof. It will be understood that user interaction with the smart mobile wallet management system 102 may occur directly via communications hardware 206, or may instead be facilitated by a separate computing device (e.g., any of enterprise computing devices 106A-106N, and/or user devices 108A-108N shown in FIG. 1, which may in turn be embodied by an apparatus 300, which is shown and described in connection with FIG. 3), and which may have similar or equivalent physical componentry facilitating such user interaction.

Turning to FIG. 4, flowchart 400 illustrates a process comprising example operations for providing automatic mDL-based transaction management for a user.

As shown by operation 402, the apparatus 200 may include means, such as processor 202, memory 204, communications hardware 206, and/or the like for receiving a transaction attempt associated with a user device (e.g., user device 108A) of a user. As described herein, a transaction attempt may be an attempt to execute the purchase of one or more goods and/or services using a payment account associated with the user, an attempt to remotely deposit a check to a payment account associated with the user, claim a disbursement payment associated with the user, and/or the like. As such, the smart mobile wallet management system 102 may be configured to integrate and/or communicate with one or more computing systems associated with an affiliated enterprise (e.g., a financial institution, banking institution, and/or the like) and/or one or more clearinghouses authorized to settle financial transactions (e.g., purchases, money transfers) between various merchants and the enterprise on behalf of one or more users.

As shown by operation 404, the apparatus 200 may include means, such as processor 202, memory 204, communications hardware 206, smart mobile wallet management circuitry 212, and/or the like for determining whether the transaction attempt is associated with one or more restricted items (e.g., alcohol, tobacco products, firearms, prescription medications, hazardous materials, controlled substances, and/or the like).

In various examples, determining whether the respective transaction attempt is associated with the one or more restricted items comprises leveraging the communications hardware 206 to receive or retrieve a digital representation of a first transaction item of one or more transaction items associated with the transaction attempt. In some examples, the digital representation of a transaction item may be a programmatically managed data structure comprising various data, identifiers, descriptions, and/or information related to the transaction item and may be received and/or retrieved based on one or more application programming interface (API) calls (e.g., program code executions) initiated and/or executed by the smart mobile wallet management circuitry 212 during the transaction attempt. In such examples, the smart mobile wallet management circuitry 212 may determine whether the first transaction item is comprised within a restricted items list by comparing (e.g., matching) data related to the digital representation of the first transaction item to one or more restricted items comprised in the restricted items list. In response to determining that the first transaction item is comprised in the restricted items list, the smart mobile wallet management circuitry 212 may classify the first transaction item as a restricted item.

As shown by operation 406, the apparatus 200 may include means, such as processor 202, memory 204, smart mobile wallet management circuitry 212, and/or the like for determining whether the transaction attempt indicates that an mDL associated with the user is comprised in the user device (e.g., user device 108A). In an instance in which a transaction attempt is associated with one or more restricted items, the smart mobile wallet management circuitry 212 may be configured to determine whether the transaction attempt indicates that an mDL associated with the user is comprised in a user device (e.g., user device 108A) and/or a smart mobile wallet associated with the user. For example, if a smart mobile wallet comprising an mDL related to the user is utilized to execute the transaction attempt, the smart mobile wallet may be configured to indicate (e.g., flag, notify) that an mDL is available to the smart mobile wallet management circuitry 212 and/or a POS terminal associated with a merchant involved in the transaction attempt.

As shown by operation 408, the apparatus 200 may include means, such as processor 202, memory 204, communications hardware 206, user authentication circuitry 210, smart mobile wallet management circuitry 212, and/or the like for authenticating the user based on the mDL associated with the user. For example, the user authentication circuitry 210 may be configured to authenticate the user based on an mDL comprised in the user's smart mobile wallet and/or user device (e.g., user device 108A) in response to determining that the transaction attempt indicates an mDL associated with the user is comprised in the smart mobile wallet and/or user device.

In some examples, the smart mobile wallet management circuitry 212 may be configured to determine desired credential data (e.g., desired mDL data) based on the one or more restricted items associated with a respective transaction attempt. The desired credential data (e.g., desire mDL data) may be associated with one or more restriction satisfaction requirements associated with the one or more restricted items. The one or more restriction satisfaction requirements may be legal requirements a user must satisfy in order to be eligible to purchase various restricted items. For example, in various jurisdictions, an individual must be at least 18 years of age in order to purchase tobacco products and/or prescription medications, 21 years of age to purchase alcohol or firearms, and/or the like. As such, the one or more restriction satisfaction requirements may be associated with various state and/or federal laws, regulations, and/or standards associated with the respective restricted items associated with a transaction attempt.

Accordingly, the smart mobile wallet management circuitry 212 may be configured to determine the relevant data (e.g., desired mDL data, desired credential data) needed in order to verify that a respective user satisfies any restriction satisfactions requirements and is thereby eligible to purchase one or more restricted items associated with a respective transaction attempt. The desired credential data (e.g., desired mDL data) determined by the smart mobile wallet management circuitry 212 may be utilized by the mDL management circuitry 208 and/or the user authentication circuitry 210 in order to facilitate an mDL-based user authentication configured to verify and/or authenticate the user during a respective transaction attempt.

Additionally, as described herein, the smart mobile wallet management circuitry 212 may be configured to compare various mDL data associated with a user's mDL to data associated with supplemental required documentation that may be necessary to execute various transaction attempts. In some examples, the supplemental required documentation may be provided to the user by an authoritative entity (e.g., a government agency, licensed entity, medical professional, and/or the like) and may indicate that the user is eligible to purchase, rent, claim, occupy, utilize, and/or otherwise access restricted and/or identity verification-dependent items or spaces. Examples of the supplemental required documentation may include, but are not limited to, restricted item purchase permits (e.g., firearm permits, hazardous material permits, hazardous chemical permits, and/or any relevant permit required to purchase a restricted item), usage permits (e.g., permits to use public spaces and/or public roads, event permits, protest permits, construction permits, and/or the like), medical prescription documentation, application documentation (e.g., loan application documentation, permit application documentation, and/or the like), and/or any relevant documentation required to purchase, rent, claim, occupy, utilize, and/or otherwise access restricted and/or identity verification-dependent items or spaces. The results of the comparison of the mDL data associated with the user to the data associated with the supplemental required documentation may be utilized by the smart mobile wallet management circuitry 212 to verify that the supplemental required documentation is indeed associated with the user and that the user is the intended recipient of the supplemental required documentation and/or any restricted and/or identity verification-dependent items or spaces associated with the supplemental required documentation.

In some examples, the smart mobile wallet management circuitry 212 may be configured to determine desired credential data (e.g., desired mDL data) based on the supplemental required documentation associated with a respective transaction attempt. The desired credential data (e.g., desire mDL data) may be associated with one or more restriction satisfaction requirements associated with the supplemental required documentation. The one or more restriction satisfaction requirements may be legal requirements a user must satisfy in order to be eligible to purchase, rent, claim, occupy, utilize, and/or otherwise access restricted and/or identity verification-dependent items or spaces. As such, the one or more restriction satisfaction requirements may be associated with various state and/or federal laws, regulations, and/or standards associated with the respective restricted and/or identity verification-dependent items or spaces associated with a transaction attempt requiring various documentation.

Accordingly, the smart mobile wallet management circuitry 212 may be configured to determine the relevant data (e.g., desired mDL data, desired credential data) needed in order to verify that a respective user satisfies any restriction satisfactions requirements and is thereby eligible to purchase, rent, claim, occupy, utilize, and/or otherwise access restricted and/or identity verification-dependent items or spaces associated with a respective transaction attempt associated with the supplemental required documentation. The desired credential data (e.g., desired mDL data) determined by the smart mobile wallet management circuitry 212 may be utilized by the mDL management circuitry 208 and/or the user authentication circuitry 210 in order to facilitate an mDL-based user authentication configured to verify and/or authenticate the user during a respective transaction attempt. Based on the result of the mDL-based user authentication, the smart mobile wallet management circuitry 212 may be configured to allow (e.g., enable, permit, facilitate payment or access) or deny (e.g., cancel, terminate, halt) a respective transaction attempt associated with the supplemental required documentation.

Furthermore, in various examples, the smart mobile wallet management circuitry 212 may be configured to generate and/or cause the display of an mDL indicium associated with an mDL related to a respective user during a respective transaction attempt. In some examples, one or more mDL indicia may be configured to be displayed via an electronic display associated with a POS terminal, a merchant-facing device, and/or an enterprise device (e.g., one or more of enterprise computing devices 106A-106N) associated with a respective transaction attempt. As such, the smart mobile wallet management circuitry 212 may be configured to leverage the communications hardware 206 to provide the one or more mDL indicia to one or more of a POS terminal, a merchant-facing device, and/or an enterprise device (e.g., one or more of enterprise computing devices 106A-106N) associated with the transaction attempt.

Turning briefly to FIG. 5, FIG. 5 depicts an example user interface 500 associated with a merchant-facing device associated with a merchant displaying mDL indicia 502 associated with a respective mDL generated by the smart mobile wallet management system 102 during the respective transaction attempt. It will be appreciated that various configurations and/or layouts of user interfaces associated with various merchant-facing devices or POS terminals may be employed by respective merchants. Accordingly, the example depicted in FIG. 5 is provided for purposes of explanation and is not intended to limit the spirit and/or the scope of the present disclosure.

As shown in FIG. 5, the mDL indicia 502 is configured as a digital representation of an mDL comprising select mDL data associated with the mDL. For example, the mDL indicia 502 comprises mDL data related to the date of birth associated with the respective user, the expiration date of the mDL, and the legal name of the user that is associated with the mDL. As such, mDL indicia (e.g., mDL indicia 502) may comprise text (e.g., date of birth, credential status information), images (e.g., user portrait image data), watermarks, logos, icons, and/or the like associated with an mDL of a user and/or an IA (e.g., a state-affiliate DMV) that issued the mDL. Additionally or alternatively, mDL indicia (e.g., mDL indicia 502) may be configured as one or more digital representations of a quick response (QR) code, data matrix, Aztec code, PDF417 code, databar, codabar, barcode, and/or the like that may be scannable by an imaging device such as a rear-facing camera of a mobile device, a barcode scanning device, and/or the like.

In various examples, the smart mobile wallet management circuitry 212 may be configured to generate unique mDL indicia (e.g., mDL indicia 502) for a respective user during a respective transaction attempt associated with the respective user. In this regard, the mDL indicia may comprise encoded data associated with the user's mDL (e.g., credential data, user portrait image data), encoded data associated with the respective transaction attempt, encoded data associated with the user (e.g., user attribute data, user payment account data), encoded data associated with the merchant related to the transaction attempt, and/or the like. As such, the encoded information associated with the mDL indicia (e.g., mDL indicia 502) may be utilized to confirm, verify, and/or otherwise authenticate the user associated with the respective transaction attempt.

Furthermore, in various examples, mDL indicia (e.g., mDL indicia 502) associated with an mDL that is provided to a merchant-facing device may be utilized by a clerk (e.g., a salesperson, cashier) to visually authenticate a user attempting to purchase various restricted items. For example, if a clerk detects a discrepancy between the mDL indicia (e.g., mDL indicia 502) displayed on the merchant-facing device and the user involved with the transaction attempt, the clerk may interact with one or more interactive user interface elements (e.g., interactive user interface element 504 configured as an interactive button) associated with the user interface (e.g., user interface 500) associated with a merchant-facing device to cancel, terminate, and/or halt the transaction attempt. This may provide an additional level of security in addition to the automatic authentication of a user executed by the smart mobile wallet management system 102 based on the mDL associated with the user.

Returning now to FIG. 4, and as shown by operation 410, the apparatus 200 may include means, such as processor 202, memory 204, smart mobile wallet management circuitry 212, and/or the like for handling the transaction attempt. For example, based on a successful mDL-based authentication of the user, the smart mobile wallet management circuitry 212 may be configured to allow (e.g., enable, permit, facilitate payment) the transaction attempt. Alternatively, based on a failed mDL-based authentication of the user, the smart mobile wallet management circuitry 212 may be configured to deny (e.g., cancel, terminate, halt) the transaction attempt.

In some examples, in response to a failed mDL-based user authentication, the smart mobile wallet management circuitry 212 may be configured to remove one or more restricted items from the transaction attempt. Additionally or alternatively, the smart mobile wallet management circuitry 212 may be configured to generate a notification describing the failed mDL-based user authentication and/or the removal of the one or more restricted items from the transaction attempt to one or more of the smart mobile wallet associated with the user, the user device associated with the user (e.g., user device 108A), the POS terminal associated with the transaction attempt, a merchant-facing device associated with the merchant involved in the transaction attempt, and/or one or more enterprise devices (e.g., one or more of the enterprise devices 106A-106N) associated with an enterprise employing the smart mobile wallet management system 102.

### CONCLUSION

As described above, example embodiments provide methods and apparatuses that provide automatic mDL-based transaction management. Example embodiments thus provide tools that overcome the problems faced by conventional payment mechanisms and techniques. By avoiding the use of conventional payment mechanisms and techniques, example embodiments thus save time and resources, while mitigating problematic scenarios in which a user may not be in possession of a physical, government-issued ID. For example, various embodiments described herein may eliminate the need for a user to provide a physical government-issued ID in order to purchases various restricted items.

Furthermore, example embodiments described herein provided an addition layer of security for the transfer of funds. For example, embodiments provide an automated means of authenticating a user based on data related to the user's mDL while facilitating the mobile deposit of checks (e.g., personal checks, certified checks) and/or the claiming of various disbursement payments (e.g., loan disbursements). Moreover, example embodiments contemplated herein provide technical solutions that solve real-world problems faced by users who wish to ensure the safety of various transaction and/or account management operations by employing various mDL-based user authentication techniques. While confirming the identity of an individual has been a technical challenge for years, the increasing occurrence of impersonation fraud (e.g., identity theft), credit card fraud, bank account fraud, and transaction fraud (both on the web and in physical retail locations) has made this problem significantly more acute. By utilizing a legally issued mDL to authenticate a user, embodiments of the present disclosure ensure that users are properly verified before the allowance of various transactions is granted, thereby increasing the security and safety of the funds associated with the payment accounts associated with the user.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for providing automatic mobile drive license (mDL)-based transaction management, the method comprising:
receiving, by communications hardware, a transaction attempt associated with a user device of a user;
determining, by smart mobile wallet management circuitry, whether the transaction attempt is associated with one or more restricted items;
in an instance in which the transaction attempt is associated with the one or more restricted items, determining, by the smart mobile wallet management circuitry, whether the transaction attempt indicates that an mDL associated with the user is comprised in the user device;
in response to determining that the transaction attempt indicates an mDL associated with the user is comprised in the user device, authenticating, by user authentication circuitry and based on the one or more restricted items, the user based on the mDL associated with the user;
handling, by the smart mobile wallet management circuitry and based on authenticating the user, the transaction attempt, wherein (a) the transaction attempt is allowed in an instance in which the user is successfully authenticated and (b) the transaction attempt is denied in an instance in which the user fails to be successfully authenticated.

2. The method of claim 1, wherein authenticating the user based on the mDL further comprises:
receiving, by the communications hardware, an mDL authentication request, wherein the mDL authentication request is a request to authenticate the mDL associated with the user;
generating, by mDL management circuitry and based on the mDL authentication request, a digital token;
transmitting, by the communications hardware, the digital token to an issuing authority (IA) system associated with an IA that provisioned the mDL to the user;
receiving, by the communications hardware and from the IA system, an mDL validity response, wherein the mDL validity response is generated based on the digital token, and wherein the mDL validity response indicates verified credential data associated with the mDL; and
authenticating, by the user authentication circuitry, the user based on the mDL validity response.

3. The method of claim 2, wherein the mDL authentication request comprises one or more of user identification data, desired credential data associated with the mDL, or user attribute data associated with the user, and
wherein the method further comprises determining, by the smart mobile wallet management circuitry, the desired credential data based on the one or more restricted items associated with the transaction attempt, wherein the desired credential data are associated with one or more restriction satisfaction requirements associated with the one or more restricted items.

4. The method of claim 3, wherein the mDL validity response further indicates verified user device identification data related to a user device associated with the user.

5. The method of claim 1, wherein authenticating the user based on the mDL further comprises:
capturing, by biometric data management circuitry, biometric data associated with the user;
comparing, by the biometric data management circuitry, captured biometric data to known biometric data associated with the user to generate a biometric data matching score, wherein one or more portions of the known biometric data are associated with the mDL related to the user;
determining, by the biometric data management circuitry, whether the biometric data matching score satisfies a biometric data matching threshold; and
in response to determining that the biometric data matching score satisfies the biometric data matching threshold, authenticating, by the user authentication circuitry, the user.

6. The method of claim 1, further comprising:
causing display, by the smart mobile wallet management circuitry, of an mDL indicium associated with the user on a merchant-facing device, wherein the mDL indicium is a digital representation of one or more portions of data related to the mDL associated with the user.

7. The method of claim 1, further comprising:
determining, by the smart mobile wallet management circuitry, whether the transaction attempt is associated with a disbursement payment claim attempt associated with the user;
in response to determining that the transaction attempt is associated with the disbursement payment claim attempt, authenticating, by the user authentication circuitry, the user based on the mDL associated with the user; and
handling, by the smart mobile wallet management circuitry and based on authenticating the user, the disbursement payment claim attempt, wherein (a) the disbursement payment claim attempt is allowed in an instance in which the user is successfully authenticated and (b) the disbursement payment claim attempt is denied in an instance in which the user fails to be successfully authenticated.

8. The method of claim 1, further comprising:
determining, by the smart mobile wallet management circuitry, whether the transaction attempt is associated with a mobile check deposit attempt;
in response to determining that the transaction attempt is associated with the mobile check deposit attempt, comparing, by the smart mobile wallet management circuitry, check data related to a check associated with the mobile check deposit attempt to mDL data associated with the mDL comprised in the user device to generate a check data matching score;
determining, by the smart mobile wallet management circuitry, whether the check data matching score satisfies a check data matching threshold, and
in response to determining whether the check data matching score satisfies the check data matching threshold, handling, by the smart mobile wallet management circuitry, the mobile check deposit attempt, wherein (a) the mobile check deposit attempt is allowed in an instance in which the user is successfully authenticated and (b) the mobile check deposit attempt is denied in an instance in which the user fails to be successfully authenticated.

9. The method of claim 1, wherein determining whether the transaction attempt is associated with the one or more restricted items further comprises:
receiving, by the communications hardware, a digital representation of a first transaction item of one or more transaction items associated with the transaction attempt;
determining, by the smart mobile wallet management circuitry and based on the digital representation, whether the first transaction item is comprised within a restricted items list; and
in response to determining the first transaction item is comprised in the restricted items list, classifying, by the smart mobile wallet management circuitry, the first transaction item as a restricted item.

10. The method of claim 1, the method further comprising:
generating, by the smart mobile wallet management circuitry and based on allowing or denying the transaction attempt, an audit trail for the transaction attempt; and
causing storage, by the smart mobile wallet management circuitry, of the audit trail in a storage device associated with a smart mobile wallet management system.

11. An apparatus for providing automatic mDL-based transaction management:
communications hardware configured to:
receive a transaction attempt associated with a user device of a user;
smart mobile wallet management circuitry configured to:
determine whether the transaction attempt is associated with one or more restricted items;
in an instance in which the transaction attempt is associated with the one or more restricted items, determine whether the transaction attempt indicates that an mDL associated with the user is comprised in the user device; and
user authentication circuitry configured to:
in response to determining that the transaction attempt indicates an mDL associated with the user is comprised in the user device, authenticate, based on the one or more restricted items, the user based on the mDL associated with the user,
wherein the smart mobile wallet management circuitry is configured to handle, based on authenticating the user, the transaction attempt, wherein (a) the transaction attempt is allowed in an instance in which the user is successfully authenticated and (b) the transaction attempt is denied in an instance in which the user fails to be successfully authenticated.

12. The apparatus of claim 11,
wherein the communications hardware is further configured to receive an mDL authentication request, wherein the mDL authentication request is a request to authenticate the mDL associated with the user,
wherein the apparatus further comprises mDL management circuitry configured to generate, based on the mDL authentication request, a digital token,
wherein the communications hardware is configured to transmit the digital token to an issuing authority (IA) system associated with an IA that provisioned the mDL to the user and receive, from the IA system, an mDL validity response, wherein the mDL validity response is generated based on the digital token, wherein the mDL validity response indicates verified credential data associated with the mDL, and
wherein the user authentication circuitry is further configured to authenticate the user based on the mDL validity response.

13. The apparatus of claim 12, wherein the mDL authentication request comprises one or more of user identification data, desired credential data associated with the mDL, or user attribute data associated with the user, and
wherein the smart mobile wallet management circuitry is further configured to determine the desired credential data based on the one or more restricted items associated with the transaction attempt, wherein the desired credential data are associated with one or more restriction satisfaction requirements associated with the one or more restricted items.

14. The apparatus of claim 13, wherein the mDL validity response further indicates verified user device identification data related to a user device associated with the user.

15. The apparatus of claim 11, wherein the apparatus further comprises:
biometric data management circuitry configured to:
capture biometric data associated with the user;
compare captured biometric data to known biometric data associated with the user to generate a biometric data matching score, wherein one or more portions of the known biometric data are associated with the mDL related to the user; and
determine whether the biometric data matching score satisfies a biometric data matching threshold, wherein the user authentication circuitry is configured to, in response to determining that the biometric data matching score satisfies the biometric data matching threshold, authenticate the user.

16. The apparatus of claim 11, wherein the smart mobile wallet management circuitry is further configured to cause display of an mDL indicium associated with the user on a merchant-facing device, wherein the mDL indicium is a digital representation of one or more portions of data related to the mDL associated with the user.

17. The apparatus of claim 11,
wherein the smart mobile wallet management circuitry is further configured to determine whether the transaction attempt is associated with a disbursement payment claim attempt associated with the user,
wherein the user authentication circuitry is further configured to, in response to determining that the disbursement payment claim attempt indicates the mDL associated with the user is comprised in the user device, authenticate the user based on the mDL associated with the user, and
wherein the smart mobile wallet management circuitry is further configured to, based on authenticating the user, handle the disbursement payment claim attempt, wherein (a) the disbursement payment claim attempt is allowed in an instance in which the user is successfully authenticated and (b) the disbursement payment claim attempt is denied in an instance in which the user fails to be successfully authenticated.

18. The apparatus of claim 11, wherein the smart mobile wallet management circuitry is further configured to:
determine whether the transaction attempt is associated with a mobile check deposit attempt;
in response to determining that the mobile check deposit attempt indicates the mDL associated with the user is comprised in the user device, compare check data related to a check associated with the mobile check deposit attempt to mDL data associated with the mDL comprised in the user device to generate a check data matching score;
determine whether the check data matching score satisfies a check data matching threshold; and
in response to determining whether the check data matching score satisfies the check data matching threshold, handle the mobile check deposit attempt, wherein (a) the mobile check deposit attempt is allowed in an instance in which the user is successfully authenticated and (b) the mobile check deposit attempt is denied in an instance in which the user fails to be successfully authenticated.

19. The apparatus of claim 11, wherein the communications hardware is further configured to receive a digital representation of a first transaction item of one or more items associated with the transaction attempt, and
wherein the smart mobile wallet management circuitry is further configured to determine whether the first transaction item is comprised within a restricted items list and, in response to determining the first transaction item is comprised in the restricted items list, classify the first transaction item as a restricted item.

20. A system for providing automatic mDL-based transaction management, wherein the system comprises:
means for receiving a transaction attempt associated with a user device of a user;
means for determining whether the transaction attempt is associated with one or more restricted items;
in an instance in which the transaction attempt is associated with the one or more restricted items, means for determining whether the transaction attempt indicates that an mDL associated with the user is comprised in the user device;
in response to determining that the transaction attempt indicates an mDL associated with the user is comprised in the user device, means for authenticating, based on the one or more restricted items, the user based on the mDL associated with the user; and
means for handling, based on authenticating the user, the transaction attempt, wherein (a) the transaction attempt is allowed in an instance in which the user is successfully authenticated and (b) the transaction attempt is denied in an instance in which the user fails to be successfully authenticated.
